(19) United States
(12) Patent Application Publication
(10) Pub. No.: US 2024/0349255 A1
(43) Pub. Date: Oct. 17, 2024

(54) METHOD AND DEVICE IN NODES USED FOR WIRELESS COMMUNICATION

(71) Applicants: Qi JIANG, SHANGHAI (CN); Xiaobo ZHANG, SHANGHAI (CN)

(72) Inventors: Qi JIANG, SHANGHAI (CN); Xiaobo ZHANG, SHANGHAI (CN)

(73) Assignee: SHANGHAI LANGBO COMMUNICATION TECHNOLOGY COMPANY LIMITED, Shanghai (CN)

(21) Appl. No.: 18/751,375

(22) Filed: Jun. 24, 2024

Related U.S. Application Data
(63) Continuation of application No. PCT/CN2022/138325, filed on Dec. 12, 2022.

(30) Foreign Application Priority Data
Dec. 31, 2021 (CN) 202111659743.6

(51) Int. Cl. H04W 72/044; H04L 5/00

(52) U.S. Cl. CPC H04W 72/044; H04L 5/0005

(57) ABSTRACT

The node firstly transmits a first information block and a second information block, the first information block indicating a first terminal capability value set, with candidates for the first terminal capability value set including K1 terminal capability values, and the second information block indicating multiple first-type time values, and the first information block and the second information block both indicating a first time value; and transmits a reference signal in each SRS resource of a first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value. This application improves the accuracy of positioning measurement under multi-panel terminals and optimizes system performance.

### CROSS REFERENCE TO RELATED APPLICATIONS

This application is the continuation of the international patent application No. PCT/CN2022/138325, filed on Dec. 12, 2022, and claims the priority benefit of Chinese Patent Application No. 202111659743.6, filed on Dec. 31, 2021, the full disclosure of which is incorporated herein by reference.

### BACKGROUND

### Technical Field

The present application relates to transmission methods and devices in wireless communication systems, and in particular to a transmission scheme and device for positioning in wireless communications.

### Related Art

The 5G radio cellular communication network system (5G-RAN) imposes more stringent requirements on the positioning accuracy and performance of UE's location than the 4G radio cellular communication network system. For example, 3GPP Technical Specification (TS) 22.261 specifically defines seven positioning performance levels, with the horizontal absolute positioning accuracy requirements ranging from a minimum of 10 m to a maximum of 0.3 m, and the vertical absolute positioning accuracy requirements ranging from a minimum of 3 m to a maximum of 2 m. R15 standard also supports Radio Access Technology (RAT)-based positioning methods utilizing 4G Long-Term Revolution (LTE) signals: such as Enhanced Cell Positioning (E-CID), Downlink Observed Time Difference of Arrival (OTDOA) and Uplink Time Difference of Arrival (UTDOA). However, the R15 standard does not yet support RAT positioning methods using NR signals. In order to compensate for this deficiency and to improve the positioning performance of NR UEs, especially in indoor environments where the Global Navigation Satellite System (GNSS) does not work properly, the 3GPP has introduced several RAT positioning methods based on NR signals in the R16 standard, i.e., NR Enhanced Cell ID Positioning Method (E-CID), NR Downlink Time Difference of Arrival Positioning Method (DL-TDOA), NR Uplink Time Difference of Arrival Positioning Method (UL-TDOA), NR Multi-Cell Round Trip Time Positioning Method (Multi-RTT), NR Downlink Angle of Departure Positioning Method (DL-AoD), and NR Uplink Angle of Arrival Positioning Method (UL-AoA).

In the discussion of NR R17, in order to further improve the positioning accuracy, the concept of TEG (i.e., Timing Error Group) has been defined at both the terminal side and the base station side to further reduce the errors on positioning due to processing delays and other reasons.

### SUMMARY

In the discussion of NR R17, enhancements are made to the transmitting of terminals, one important aspect of which is the introduction of the reporting of UE Capability Value Sets, where each reported UE Capability Value Set includes at least one value corresponding to the maximum number of Sounding Reference Signal ports (SRS Ports) supported by the user terminal, and each UE Capability Value Set corresponds to a Panel of the user terminal. The RF capability of the UE is communicated to the base station via the above report. However, for positioning-related application scenarios, the above reporting needs to be further enhanced incorporating the concept of TEG.

The present application discloses a solution to address the above problem of positioning in multi-panel scenarios. It should be noted that in the description of the present application, multiple panels are only used as an exemplary application scenario or example; the present application is equally applicable to other scenarios facing similar problems, such as single-panel scenarios, or scenarios where there is joint collaboration between multiple base stations, or base stations or UEs with enhanced capabilities, or for different technical fields, such as measurements other than positioning measurements such as Reference Signal Received Power (RSRP) measurements, interference measurements, and other non-positioning measurements to achieve similar technical results. Additionally, the adoption of a unified solution for various scenarios, including but not limited to multi-panel scenario, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
transmitting a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and
transmitting a reference signal in each SRS resource of a first time-frequency resource set, the first time-frequency resource set comprising at least one SRS resource;
herein, the first time-frequency resource set is known at a location-based service center, and a transmission timing error of a reference signal transmitted in any SRS resource of the first time-frequency resource set does not exceed the first time value.
In one embodiment, the above method is characterized in that as compared to the conventional way of indicating TEGs, the second information block in the present application indicates multiple TEGs, and the first information block in the present application indicates one TEG, i.e., the first time value, from the multiple TEGs indicated by the second information block.

In one embodiment, the above method is characterized in that one TEG is indicated more accurately out of the multiple TEGs associated with the Panels to improve positioning accuracy.

According to one aspect of the present application, comprising:
transmitting a first CSI (i.e., Channel State Information) set, the first CSI set comprising at least one CSI;
herein, the first information block indicates that the first CSI set is associated with the first terminal capability value set.

In one embodiment, the above method is characterized in that: the above indication of the TEG is realized through CSI reporting.

In one embodiment, the above method is characterized also in that the Channel State Information Reference Signal (CSI-RS) resource on which the reported CSI is based is Quasi Co-located (QCL) with the SRS resource associated with the reported TEG.

According to one aspect of the present application, comprising:
receiving a third information block;
herein, the third information block is used to determine a first time-frequency resource pool, the first time-frequency resource pool comprising the first time-frequency resource set.

According to one aspect of the present application, the second information block is used to indicate a first identity, the first time-frequency resource set being associated with the first identity.

According to one aspect of the present application, comprising:
receiving a first signal in a second time-frequency resource set;
herein, the first signal is used to generate the first CSI set.

According to one aspect of the present application, a receiver of the reference signal transmitted in each SRS resource of the first time-frequency resource set includes a second node, the second node being associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes Relative Time of Arrival (RTOA); the first reference signal is a reference signal transmitted in at least one SRS resource of the first time-frequency resource set.

According to one aspect of the present application, comprising:
receiving a fourth information block;
herein, the fourth information block is used to trigger that the first information block and the second information block are used together to indicate the first time value; a measurement result for transmitting the reference signal in the SRS resource in the first time-frequency resource set is a second measurement value set; a type of the second measurement value set is either a first type or a second type; the first type includes UL TDOA, and the second type includes multi-RTT; a type of a transmitter of the fourth information block is one of a base station or Location Management Function (LMF); the type of the second measurement value set is used to determine a type of a receiver of the second measurement value set.

The present application provides a method in a second node for wireless communications, comprising:
receiving a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and receiving a reference signal in each SRS resource of a first time-frequency resource set, the first time-frequency resource set comprising at least one SRS resource;
herein, the first time-frequency resource set is known at a location-based service center, and a transmission timing error of a reference signal transmitted in any SRS resource of the first time-frequency resource set does not exceed the first time value.

According to one aspect of the present application, comprising:
receiving a first CSI set, the first CSI set comprising at least one CSI;
herein, the first information block indicates that the first CSI set is associated with the first terminal capability value set.

According to one aspect of the present application, comprising:
transmitting a third information block;
herein, the third information block is used to determine a first time-frequency resource pool, the first time-frequency resource pool comprising the first time-frequency resource set.

According to one aspect of the present application, the second information block is used to indicate a first identity, the first time-frequency resource set being associated with the first identity.

According to one aspect of the present application, comprising:
transmitting a first signal in a second time-frequency resource set;
herein, the first signal is used to generate the first CSI set.

According to one aspect of the present application, the second node is associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes RTOA; the first reference signal is a reference signal transmitted in at least one SRS resource of the first time-frequency resource set.

According to one aspect of the present application, comprising:
transmitting a fourth information block;
herein, the fourth information block is used to trigger that the first information block and the second information block are used together to indicate the first time value; a measurement result for transmitting the reference signal in the SRS resource in the first time-frequency resource set is a second measurement value set; a type of the second measurement value set is either a first type or a second type; the first type includes UL TDOA, and the second type includes multi-RTT; a type of the second node is one of a base station or LMF; the type of the second measurement value set is used to determine a type of a receiver of the second measurement value set.

The present application provides a first node for wireless communications, comprising:
a first transmitter, transmitting a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and transmitting a reference signal in each SRS resource of a first time-frequency resource set, the first time-frequency resource set comprising at least one SRS resource;
herein, the first time-frequency resource set is known at a location-based service center, and a transmission timing error of a reference signal transmitted in any SRS resource of the first time-frequency resource set does not exceed the first time value.

The present application provides a second node for wireless communications, comprising:
a first receiver, receiving a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and receiving a reference signal in each SRS resource of a first time-frequency resource set, the first time-frequency resource set comprising at least one SRS resource;
herein, the first time-frequency resource set is known at a location-based service center, and a transmission timing error of a reference signal transmitted in any SRS resource of the first time-frequency resource set does not exceed the first time value.

In one embodiment, the benefits of the scheme in this application are: improved accuracy of TEG indication and optimized positioning performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first information block and a second information block according to one embodiment of the present application.

FIG. 6 illustrates a flowchart of a first CSI set according to one embodiment of the present application.

FIG. 7 illustrates a flowchart of a first measurement value set according to one embodiment of the present application.

FIG. 8 illustrates a flowchart of a fourth information block according to one embodiment of the present application.

FIG. 9 illustrates a schematic diagram of a first terminal capability value according to one embodiment of the present application.

FIG. 10 illustrates a schematic diagram of antenna ports and antenna port groups according to one embodiment of the present application.

FIG. 11 illustrates a structure block diagram of a processing device in a first node according to one embodiment of the present application.

FIG. 12 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

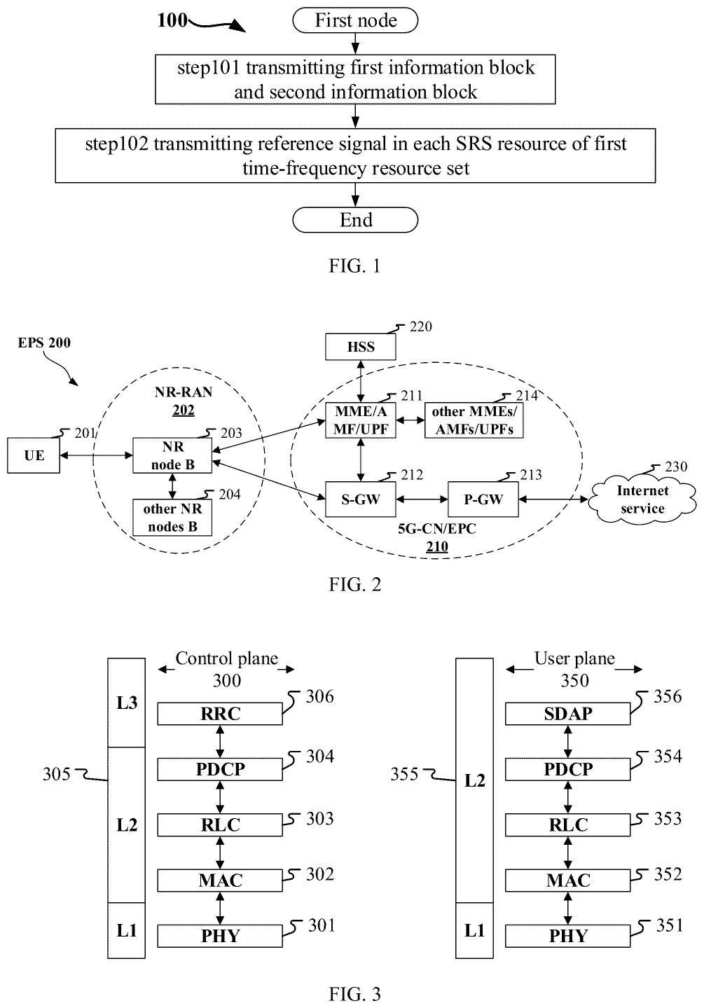

Embodiment 1 illustrates a flowchart of processing of a first node, as shown in FIG. 1. In 100 illustrated by FIG. 1, each box represents a step. In Embodiment 1, the first node in the present application transmits a first information block and a second information block in step 101; and transmits a reference signal in each SRS resource of the first time-frequency resource set in step 102.

In Embodiment 1, the first information block indicates a first terminal capability value set, with candidates for the first terminal capability value set including K1 terminal capability values, and the second information block indicates multiple first-type time values, and the first information block and the second information block both indicating a first time value, the first time value being one of the multiple first-type time values; the first time-frequency resource set comprises at least one SRS resource; the first time-frequency resource set is known at a location-based service center, and a transmission timing error of a reference signal transmitted in any SRS resource of the first time-frequency resource set does not exceed the first time value.

In one embodiment, the first information block is transmitted via a Radio Resource Control (RRC) signaling.

In one embodiment, the first information block is transmitted via a Medium Access Control (MAC) layer signaling.

In one embodiment, the first information block is transmitted via a physical layer signaling.

In one embodiment, the first information block is transmitted via Uplink Control Information (UCI).

In one embodiment, the first information block is transmitted via a CSI.

In one embodiment, the first information block is reported through a beam management procedure.

Typically, the first information block indicates a first index, the first index being associated with the first terminal capability value set.

In one embodiment, the first node comprises M1 terminal capability value sets, the first terminal capability value set being one of the M1 terminal capability value sets, M1 being a positive integer greater than 1.

In one subembodiment, the first information block is used to indicate the first terminal capability value set from the M1 terminal capability value sets.

In one subembodiment, M1 is equal to 2, and the M1 terminal capability value sets are the first terminal capability value set and the second terminal capability value set, respectively.

In one subembodiment, the M1 terminal capability value sets correspond to M1 panels of the first node, respectively.

In one subembodiment, any terminal capability value set of the M1 terminal capability value sets corresponds to one or more SRS ports.

In one subembodiment, any terminal capability value set of the M1 terminal capability value sets corresponds to one or more SRS resources.

In one subembodiment, any terminal capability value set of the M1 terminal capability value sets corresponds to one or more SRS resource sets.

In one embodiment, a candidate for the first terminal capability value set comprises only 1 terminal capability value, K1 being equal to 1.

In one embodiment, a candidate for the first terminal capability value set comprises multiple terminal capability values, K1 being a positive integer greater than 1.

In one embodiment, a candidate for the first terminal capability value set comprises only 1 terminal capability value, K1 being equal to 1, and the terminal capability value included in the candidate for the first terminal capability value set represents the maximum supported number of SRS ports.

In one embodiment, a candidate for the first terminal capability value set comprises multiple terminal capability values, K1 being a positive integer greater than 1, and one of the K1 terminal capability values indicates the maximum supported number of SRS ports, and the K1 terminal capability values also include another terminal capability value indicating the maximum supported number of SRS resources.

In one embodiment, a candidate for the first terminal capability value set comprises multiple terminal capability values, K1 being a positive integer greater than 1, and one of the K1 terminal capability values indicates the maximum supported number of SRS ports, and the K1 terminal capability values also include another terminal capability value indicating the maximum supported number of SRS resource sets.

In one embodiment, a candidate for the first terminal capability value set comprises multiple terminal capability values, K1 being a positive integer greater than 1, and the K1 terminal capability values each indicate one of K1 different numbers of SRS ports being supported.

In one embodiment, the second information block indicates M1 first-type time values, M1 being a positive integer greater than 1.

In one subembodiment, any of the M1 first-type time values is measured in the unit of milliseconds.

In one subembodiment, any of the M1 first-type time values is measured in the unit of microseconds.

In one subembodiment, any of the M1 first-type time values is measured in the unit of nanoseconds.

In one subembodiment, the first node comprises M1 terminal capability value sets and the M1 first-type time values are each associated to an SRS port in the M1 terminal capability value sets.

In one subsidiary embodiment of the above subembodiment, a given first-type time value is any first-type time value of the M1 first-type time values, the given first-type time value being associated to a given terminal capability value set among the M1 terminal capability value sets, the given first-type time value representing a margin of transmission timing error when transmitting a signal for positioning using one SRS port in the given terminal capability value set.

In one subembodiment, the first node comprises M1 terminal capability value sets and the M1 first-type time values are each associated to an SRS resource in the M1 terminal capability value sets.

In one subsidiary embodiment of the above subembodiment, a given first-type time value is any first-type time value of the M1 first-type time values, the given first-type time value being associated to a given terminal capability value set among the M1 terminal capability value sets, the given first-type time value representing a margin of transmission timing error when transmitting a signal for positioning using one SRS resource in the given terminal capability value set.

In one subembodiment, the first node comprises M1 terminal capability value sets and the M1 first-type time values are each associated to an SRS resource set in the M1 terminal capability value sets.

In one subsidiary embodiment of the above subembodiment, a given first-type time value is any first-type time value of the M1 first-type time values, the given first-type time value being associated to a given terminal capability value set among the M1 terminal capability value sets, the given first-type time value representing a margin of transmission timing error when transmitting a signal for positioning using at least one SRS resource included in an SRS resource set in the given terminal capability value set.

In one subembodiment, any of the M1 first-type time values corresponds to a Timing Error Group (TEG).

In one subsidiary embodiment of the above subembodiment, any of the M1 first-type time values is a maximum timing error for the corresponding TEG.

In one subsidiary embodiment of the above subembodiment, any of the M1 first-type time values is a margin of timing error for the corresponding TEG.

In one subsidiary embodiment of the above subembodiment, the TEG corresponding to any of the M1 first-type time values is a transmitting TEG of the first node.

In one subembodiment, any of the M1 first-type time values corresponds to a TEG ID.

In one embodiment, the above phrase the first information block and the second information block both indicating a first time value comprises: the first node comprising M1 terminal capability value sets, the first information block being used to indicate the first terminal capability value set from the M1 terminal capability value sets, the first terminal capability value set being associated with Q1 first-type time values, the second information block being used to indicate the first time value from the Q1 first-type time values, Q1 being a positive integer greater than 1.

In one embodiment, the first node comprises M1 terminal capability value sets, any of the M1 terminal capability value sets being associated to Q2 first-type time values, Q2 being a positive integer greater than 1.

In one subembodiment, the second information block comprises L1 bits, Q2 being a positive integer not greater than the L1-th power of 2.

In one subembodiment, the phrase any of the M1 terminal capability value sets being associated to Q2 first-type time values comprises: a given terminal capability value set being any one of the M1 terminal capability value sets, the given terminal capability value set being associated to Q2 SRS resources, the Q2 SRS resources being respectively associated to the Q2 first-type time values.

In one subsidiary embodiment of the above subembodiment, the above phrase the Q2 SRS resources being respectively associated to the Q2 first-type time values comprises: a given SRS resource being any one of the Q2 SRS resources, the given first-type time value being a first-type time value of the Q2 first-type time values being associated with the given SRS resource, the given first-type time value representing a margin of transmission timing error when transmitting a signal for positioning using the given SRS resource.

In one subembodiment, the phrase any of the M1 terminal capability value sets being associated to Q2 first-type time values comprises: a given terminal capability value set being any one of the M1 terminal capability value sets, the given terminal capability value set being associated to Q2 SRS resource sets, the Q2 SRS resource sets being respectively associated to the Q2 first-type time values.

In one subsidiary embodiment of the above subembodiment, the above phrase the Q2 SRS resource sets being respectively associated to the Q2 first-type time values comprises: a given SRS resource set being any one of the Q2 SRS resource sets, the given first-type time value being a first-type time value of the Q2 first-type time values being associated with the given SRS resource set, the given first-type time value representing a margin of transmission timing error when transmitting a signal for positioning using one or more SRS resources in the given SRS resource set.

In one embodiment, the first time-frequency resource set comprises more than one Resource Element (RE).

In one embodiment, the first time-frequency resource set comprises only one SRS resource.

In one embodiment, the first time-frequency resource set comprises only one SRS resource set.

In one embodiment, the first time-frequency resource set comprises multiple SRS resources.

In one embodiment, the first time-frequency resource set comprises multiple SRS resource sets.

In one embodiment, the SRS resource in this application is associated to an SRS Resource Indicator (SRI).

In one embodiment, the SRS resource in this application is associated to an SRS Resource Set ID.

In one embodiment, the SRS resource in this application is associated to an SRS Resource Index.

In one embodiment, the above phrase “the first time-frequency resource set is known at a location-based service center” comprises that the first time-frequency resource set is configured directly through the location-based service center.

In one embodiment, the above phrase “the first time-frequency resource set is known at a location-based service center” comprises that the first time-frequency resource set is configured to the base station through the location-based service center, and then configured by the base station to the first node.

In one embodiment, the above phrase “the first time-frequency resource set is known at a location-based service center” comprises that the first time-frequency resource set is unknown at the base station.

In one embodiment, the above phrase “the first time-frequency resource set is known at a location-based service center” comprises that the first time-frequency resource set is communicated to a serving base station of the first node via the first node.

In one embodiment, the above phrase “the first time-frequency resource set is known at a location-based service center” comprises that the first time-frequency resource set is configured in accordance with the LTE Positioning Protocol (LPP).

In one embodiment, the above phrase “the first time-frequency resource set is known at a location-based service center” comprises that the first time-frequency resource set is configured in accordance with the NR Positioning Protocol A (NRPPA).

In one embodiment, the location-based service center includes LMF.

In one embodiment, the location-based service center includes Access and Mobility Management Function (AMF).

In one embodiment, the transmission timing error comprises: a time delay between the generation of a digital signal from the baseband and the transmission of the RF signal at the transmitting antenna.

In one embodiment, the transmission timing error comprises: a transmission time delay after calibration/compensation of a relative time delay between different RF chains of the same UE.

In one embodiment, the transmission timing error comprises: a transmission time delay after considering an offset of a Tx Antenna Phase Center from a Physical Antenna Center.

In one embodiment, the transmission timing error comprises: a transmission time delay after calibration/compensation of a relative time delay between different RF chains of the same UE.

In one embodiment, the transmission timing error comprises: a transmission time delay (Tx Time Delay) remaining after the End's Calibration.

In one embodiment, the transmission timing error comprises: a transmission time delay (Tx Time Delay) for which the End is not compensated.

In one embodiment, the multiple first-type time values indicated by the second information block use the same TEG ID.

Typically, the first information block and the second information block are used together to determine that the first time-frequency resource set is associated with the first time value.

Typically, the first information block and the second information block are used together to determine that the first time value is associated to the first time-frequency resource set.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, an Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE201 supports simultaneous transmitting of multiple Panels.

In one embodiment, the UE201 supports positioning based on multi-Panel transmitting.

In one embodiment, the UE201 supports multiple uplink Radio Frequencies (RFs).

In one embodiment, the UE201 supports multiple uplink RFs to be transmitted simultaneously.

In one embodiment, the UE201 supports reporting of multiple UE capability value sets.

In one embodiment, the NR node B corresponds to the second node in the present application.

In one embodiment, the NR node B supports receiving signals from multiple Panels of a terminal simultaneously.

In one embodiment, the NR node B supports positioning based on signals sent by multiple Panels of a terminal.

In one embodiment, the NR node B supports receiving signals sent by multiple uplink Radio Frequencies (RFs) from the same terminal.

In one embodiment, the NR node B is a base station.

In one embodiment, the NR node B is a LMF.

In one embodiment, the NR node B is an AMF.

In one embodiment, the NR node B is a node for positioning.

In one embodiment, the first node in the present application corresponds to the UE201, and the second node in the present application corresponds to the NR node B.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The Radio Resource Control (RRC) sublayer 306 in the L3 is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first information block is generated by the MAC302 or the MAC352.

In one embodiment, the first information block is generated by the PHY 301, or the PHY 351.

In one embodiment, the first information block is generated by the MAC302 or the MAC352.

In one embodiment, the first information block is generated by the RRC 306.

In one embodiment, the first information block is generated by the NAS.

In one embodiment, the second information block is generated by the MAC302 or the MAC352.

In one embodiment, the second information block is generated by the PHY 301 or the PHY 351.

In one embodiment, the second information block is generated by the MAC302 or the MAC352.

In one embodiment, the second information block is generated by the RRC 306.

In one embodiment, the second information block is generated by the NAS.

In one embodiment, the reference signal transmitted in each SRS resource of the first time-frequency resource set is generated by the MAC 302 or the MAC 352.

In one embodiment, the reference signal transmitted in each SRS resource of the first time-frequency resource set is generated by the PHY 301 or the PHY 351.

In one embodiment, the first CSI set is generated by the MAC302 or the MAC352.

In one embodiment, the first CSI set is generated by the PHY 301 or the PHY 351.

In one embodiment, the first CSI set is generated by the RRC 306.

In one embodiment, the third information block is generated by the MAC302 or the MAC352.

In one embodiment, the third information block is generated by the PHY 301 or the PHY 351.

In one embodiment, the third information block is generated by the RRC 306.

In one embodiment, the first signal is generated by the MAC302 or the MAC352.

In one embodiment, the first signal is generated by the PHY 301 or the PHY 351.

In one embodiment, the first signal is generated by the RRC 306.

In one embodiment, the fourth information block is generated by the PHY 301 or the PHY 351.

In one embodiment, the fourth information block is generated by the MAC302 or the MAC352.

In one embodiment, the fourth information block is generated by the RRC 306.

In one embodiment, the fourth information block is generated by the NAS.

In one embodiment, the first measurement value set is generated by the PHY 301 or the PHY 351.

In one embodiment, the first measurement value set is generated by the MAC302 or the MAC352.

In one embodiment, the first measurement value set is generated by the RRC 306.

In one embodiment, the first measurement value set is generated by the NAS.

In one embodiment, the second measurement value set is generated by the PHY 301 or the PHY 351.

In one embodiment, the second measurement value set is generated by the MAC302 or the MAC352.

In one embodiment, the second measurement value set is generated by the RRC 306.

In one embodiment, the second measurement value set is generated by the NAS.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

In one embodiment, the second node is a node for positioning.

In one embodiment, the second node is a LME

In one embodiment, the second node is an AMF.

In one embodiment, the second node is a location-based service center.

### Embodiment 4

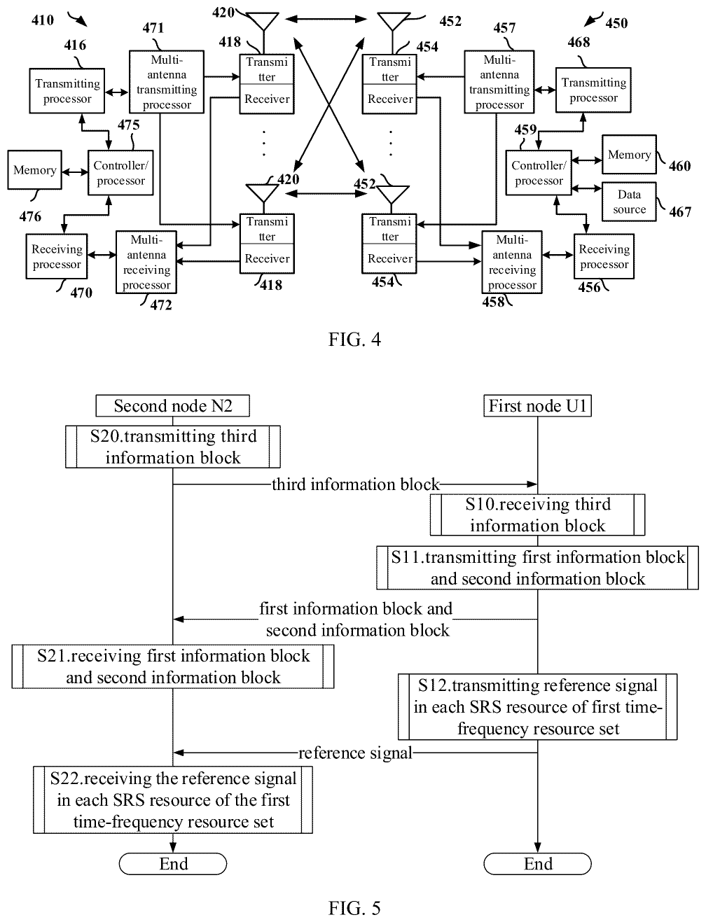

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly transmits a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and then transmits a reference signal in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value.

In one embodiment, the first communication device 450 comprises a memory that stores a computer readable instruction program. The computer readable instruction program generates actions when executed by at least one processor. The actions include: firstly transmitting a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and then transmitting a reference signal in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value.

In one embodiment, the second communication device 410 comprises at least one processor and at least one memory. The at least one memory comprises computer program codes; the at least one memory and the computer program codes are configured to be used in collaboration with the at least one processor. The second communication device 410 at least firstly receives a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and then receives a reference signal in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value.

In one embodiment, the second communication device 410 comprises a memory that stores a computer readable instruction program. The computer readable instruction program generates actions when executed by at least one processor. The actions include: firstly receiving a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and then receiving a reference signal in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is network equipment.

In one embodiment, the second communication device 410 is a serving cell.

In one embodiment, the second communication device 410 is a TRP.

In one embodiment, the second communication device 410 is a location-based service center.

In one embodiment, the second communication device 410 is a LME

In one embodiment, the second communication device 410 is an AMF.

In one embodiment, at least the first four of the antenna 452, the transmitter 454, the multi-antenna transmitting processor 457, the transmitting processor 468 and the controller/processor 459 are used for transmitting the first information block and the second information block; at least the first four of the antenna 420, the receiver 418, the multi-antenna receiving processor 472, the receiving processor 470 and the controller/processor 475 are used for receiving the first information block and the second information block.

In one embodiment, at least the first four of the antenna 452, the transmitter 454, the multi-antenna transmitting processor 457, the transmitting processor 468, and the controller/processor 459 are used for transmitting a reference signal in each SRS resource of the first time-frequency resource set; at least the first four of the antenna 420, the receiver 418, the multi-antenna receiving processor 472, the receiving processor 470 and the controller/processor 475 are used for receiving a reference signal in each SRS resource of the first time-frequency resource set.

In one embodiment, at least the first four of the antenna 452, the transmitter 454, the multi-antenna transmitting processor 457, the transmitting processor 468 and the controller/processor 459 are used for transmitting the first CSI set; at least the first four of the antenna 420, the receiver 418, the multi-antenna receiving processor 472, the receiving processor 470 and the controller/processor 475 are used for receiving the first CSI set.

In one embodiment, at least the first four of the antenna 452, the receiver 454, the multi-antenna receiving processor 458, the receiving processor 456, and the controller/processor 459 are used for receiving a third information block; at least the first four of the antenna 420, the transmitter 418, the multi-antenna transmitting processor 471, the transmitting processor 416 and the controller/processor 475 are used for transmitting a third information block.

In one embodiment, at least the first four of the antenna 452, the receiver 454, the multi-antenna receiving processor 458, the receiving processor 456, and the controller/processor 459 are used for receiving the first signal in the second time-frequency resource set; at least the first four of the antenna 420, the transmitter 418, the multi-antenna transmitting processor 471, the transmitting processor 416 and the controller/processor 475 are used for transmitting the first signal in the second time-frequency resource set.

In one embodiment, at least the first four of the antenna 452, the receiver 454, the multi-antenna receiving processor 458, the receiving processor 456, and the controller/processor 459 are used for receiving the fourth information block; at least the first four of the antenna 420, the transmitter 418, the multi-antenna transmitting processor 471, the transmitting processor 416 and the controller/processor 475 are used for transmitting the fourth information block.

### Embodiment 5

Embodiment 5 illustrates a flowchart of a first information block and a second information block, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to any of Embodiments 6, 7 or 8; conversely, in case of no conflict, the embodiments, sub-embodiments, and subsidiary embodiments in any of Embodiments 6, 7 or 8 can be applied to Embodiment 5.

The first node U1 receives a third information block in step S10; transmits a first information block and a second information block in step S11; and transmits a reference signal in each SRS resource of a first time-frequency resource set in step S12.

The second node N2 transmits the third information block in step S20; receives the first information block and the second information block in step S21; and receives the reference signal in each SRS resource of the first time-frequency resource set in step S22.

In Embodiment 5, the first information block indicates a first terminal capability value set, with candidates for the first terminal capability value set including K1 terminal capability values, and the second information block indicates multiple first-type time values, and the first information block and the second information block both indicating a first time value, the first time value being one of the multiple first-type time values; the first time-frequency resource set comprises at least one SRS resource; the first time-frequency resource set is known at a location-based service center, and a transmission timing error of a reference signal transmitted in any SRS resource of the first time-frequency resource set does not exceed the first time value; the third information block is used to determine a first time-frequency resource pool, the first time-frequency resource pool comprising the first time-frequency resource set.

In one embodiment, the first time-frequency resource pool is configured to be used for SRS transmission.

In one embodiment, the third information block is transmitted through an RRC signaling.

In one embodiment, the first time-frequency resource pool comprises multiple SRS resources.

In one subembodiment, any one of the multiple SRS resources is associated to the first terminal capability value set.

In one subembodiment, any one of the multiple SRS resources is associated to a panel.

In one embodiment, the first time-frequency resource pool comprises multiple SRS resource sets.

In one subembodiment, any one of the multiple SRS resource sets is associated to the first terminal capability value set.

In one subembodiment, any one of the multiple SRS resource sets is associated to a panel.

In one embodiment, the third information block indicates the first time-frequency resource pool.

In one embodiment, the first time-frequency resource pool comprises a positive integer number of REs.

In one embodiment, a radio signal transmitted in the first time-frequency resource pool is associated with a TEG ID.

In one embodiment, the first time-frequency resource pool is used for transmitting SRS.

### Embodiment 6

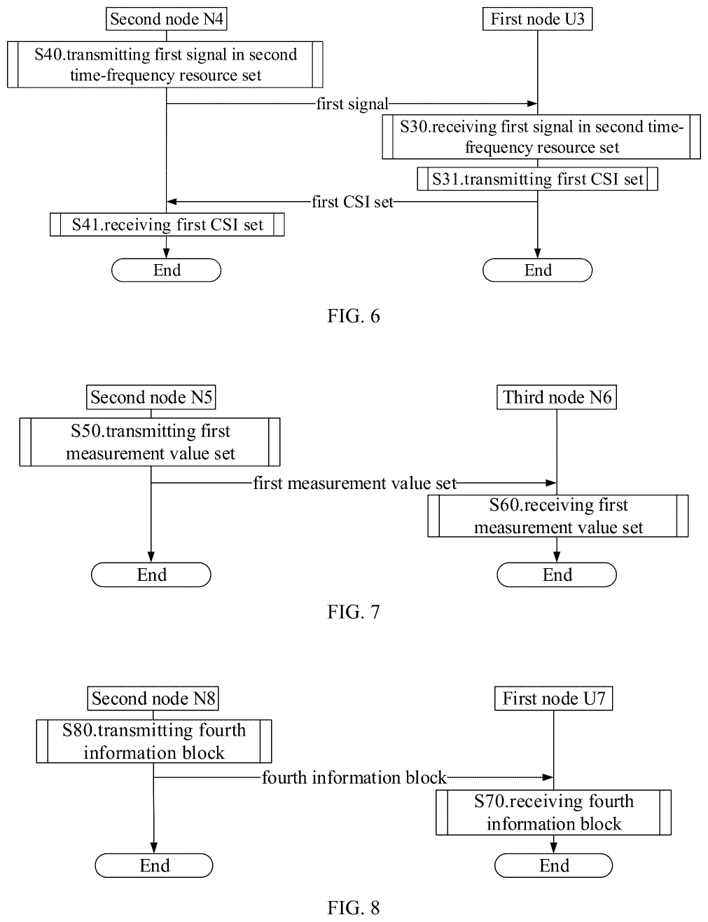

Embodiment 6 illustrates a flowchart of a first CSI set, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to any of Embodiments 5, 7 or 8; conversely, in case of no conflict, the embodiments, sub-embodiments, and subsidiary embodiments in any of Embodiments 5, 7 or 8 can be applied to Embodiment 6.

The first node U3 receives a first signal in a second time-frequency resource set in step S30; and transmits a first CSI set in step S31.

The second node N4 transmits the first signal in the second time-frequency resource set in step S40; and receives the first CSI set in step S41.

In Embodiment 6, the first CSI set comprises at least one CSI; the first information block indicates that the first CSI set is associated with the first terminal capability value set; the first signal is used to generate the first CSI set.

In one embodiment, the first CSI set comprises only one piece of Channel State Information (CSI).

In one embodiment, the first CSI set comprises multiple CSIs.

In one embodiment, the first CSI set comprises a SS/PBCH Block Resource indicator (SSBRI).

In one embodiment, the first CSI set comprises a CSI-RS Resource Indicator (CRI).

In one embodiment, the first CSI set comprises an L1-RSRP.

In one embodiment, the first CSI set comprises a L1-Signal to Interference & Noise Ratio (L1-SINR).

In one embodiment, the first CSI set comprises a Channel Quality Indicator (CQI).

In one embodiment, the first CSI set comprises a Precoding Matrix Indicator (PMI).

In one embodiment, the first CSI set comprises a Rank Indicator (RI).

In one embodiment, the first CSI set and the first information block are transmitted over a physical channel.

In one subembodiment, the physical channel is a Physical Uplink Control Channel (PUCCH).

In one subembodiment, the physical channel is a Physical Uplink Shared Channel (PUSCH).

In one embodiment, the first CSI set and the first information block are transmitted via a MAC signaling.

In one embodiment, the first signal comprises a CSI-RS.

In one embodiment, the first signal comprises an SSB.

In one embodiment, the second time-frequency resource set comprises a CSI-RS resource.

In one embodiment, the second time-frequency resource set comprises multiple CSI-RS resources.

In one embodiment, the second time-frequency resource set occupies a positive integer number of Resource Elements (REs).

In one embodiment, the first signal and an SRS transmitted in the first time-frequency resource set are QCL.

In one embodiment, the second time-frequency resource set corresponds to a CRI, and the second information block is used to indicate the CRI to which the second time-frequency resource set corresponds.

In one embodiment, the second time-frequency resource set corresponds to multiple CRIs, and the second information block is used to indicate the multiple CRIs to which the second time-frequency resource set corresponds.

In one embodiment, the second time-frequency resource set corresponds to a SSBRI, and the second information block is used to indicate the SSBRI to which the second time-frequency resource set corresponds.

In one embodiment, the second time-frequency resource set corresponds to multiple SSBRIs, and the second information block is used to indicate the multiple SSBRIs to which the second time-frequency resource set corresponds.

In one embodiment, the QCL type in the present application includes QCL-TypeA.

In one embodiment, the QCL type in the present application includes QCL-TypeB.

In one embodiment, the QCL type in the present application includes QCL-TypeC.

In one embodiment, the QCL type in the present application includes QCL-TypeD.

In one embodiment, the QCL-TypeA comprises Doppler shift, Doppler spread, average delay and delay spread.

In one embodiment, the QCL-TypeB comprises Doppler shift and Doppler spread.

In one embodiment, the QCL-TypeC comprises Doppler shift and average delay.

In one embodiment, the QCL-TypeD comprises Spatial Rx parameter.

In one embodiment, the large-scale properties include one or more of a delay spread, a Doppler spread, a Doppler shift, or an average delay or a Spatial Rx parameter.

In one embodiment, the step S30 is located before the step S10 in Embodiment 5.

In one embodiment, the step S30 is located after the step S10 and before the step S11 in Embodiment 5.

In one embodiment, the step S40 is located before the step S20 in Embodiment 5.

In one embodiment, the step S40 is located after the step S20 and before the step S21 in Embodiment 5.

In one embodiment, the step S31 is located before the step S10 in Embodiment 5.

In one embodiment, the step S31 is located after the step S10 and before the step S11 in Embodiment 6.

In one embodiment, the step S31 is part of the step S11 in Embodiment 6.

In one embodiment, the step S41 is located before the step S20 in Embodiment 5.

In one embodiment, the step S41 is located after the step S20 and before the step S21 in Embodiment 6.

In one embodiment, the step S41 is part of the step S21 in Embodiment 6.

### Embodiment 7

Embodiment 7 illustrates a flowchart of a first measurement value set, as shown in FIG. 7. In FIG. 7, a second node N5 and a third node N6 are in communication via an N2 interface. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to any of Embodiments 5, 6 or 8; conversely, in case of no conflict, the embodiments, sub-embodiments, and subsidiary embodiments in any of Embodiments 5, 6 or 8 can be applied to Embodiment 7.

The second node N5 transmits a first measurement value set in step S50.

The third node N6 receives a first measurement value set in step S60.

In Embodiment 6, the second node is associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes RTOA; the first reference signal is a reference signal transmitted in at least one SRS resource of the first time-frequency resource set.

In one embodiment, any of the L1 second-type time values is measured in the unit of milliseconds.

In one embodiment, any of the L1 second-type time values is measured in the unit of microseconds.

In one embodiment, any of the L1 second-type time values is measured in the unit of nanoseconds.

In one embodiment, the L1 second-type time values correspond to L1 TRP Rx TEGs, respectively.

In one embodiment, the L1 second-type of time values correspond to L1 TEG IDs, respectively.

In one embodiment, the L1 second-type time values correspond to L1 RFs of the second node, respectively.

In one embodiment, the L1 second-type time values correspond to L1 receiving antennas of the second node, respectively.

In one embodiment, the L1 second-type time values correspond to L1 receiving antenna ports of the second node, respectively.

In one embodiment, the L1 second-type time values correspond to L1 receiving antenna port groups of the second node, respectively.

In one embodiment, a given second time value is any one of the L1 second-type time values, a margin of reception timing error that one or more uplink measurements (UL Measurements) associated with the given second time value have.

In one subembodiment, the phrase “one or more UL Measurements associated with the given second time value” comprises the following: the given second time value is associated with a given RF, the given second time value being a margin of reception timing error resulting from performing uplink measurements of SRS transmitted in the first time-frequency resource set using the given RF.

In one subembodiment, the phrase “one or more UL Measurements associated with the given second time value” comprises the following: the given second time value is associated with a given Rx antenna, the given second time value being a margin of reception timing error resulting from performing uplink measurements of SRS transmitted in the first time-frequency resource set using the given Rx antenna.

In one embodiment, the reception timing error in the present application comprises: a time delay from the arrival of the RF channel at the receiving antenna to the time when the signal is digitized in baseband and Time Stamped.

In one embodiment, the reception timing error in the present application comprises: a reception time delay after calibration/compensation of a relative time delay between different RF chains of the same TRP.

In one embodiment, the reception timing error in the present application comprises: a reception time delay after considering an offset of a Rx Antenna Phase Center from a Physical Antenna Center.

In one embodiment, the reception timing error in the present application comprises: a reception time delay after calibration/compensation of a relative time delay between different RF chains of the same TRP.

In one embodiment, the reception timing error in the present application comprises: a reception time delay (Rx Time Delay) remaining after the TRP Calibration.

In one embodiment, the reception timing error in the present application comprises: a reception time delay for which the TRP is not compensated.

In one embodiment, the first measurement value set is transmitted on a Backhaul Link.

In one embodiment, the step S50 is located after the step S22 in Embodiment 5.

### Embodiment 8

Embodiment 8 illustrates a flowchart of a fourth information block, as shown in FIG. 8. In FIG. 8, a first node U7 and a second node N8 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 8 can be applied to any of Embodiments 5, 6 or 7; conversely, in case of no conflict, the embodiments, sub-embodiments, and subsidiary embodiments in any of Embodiments 5, 6 or 7 can be applied to Embodiment 8.

The first node U7 receives a fourth information block in step S70.

The second node N8 transmits the fourth information block in step S80.

In Embodiment 8, the fourth information block is used to trigger that the first information block and the second information block are used together to indicate the first time value; a measurement result for transmitting the reference signal in the SRS resource in the first time-frequency resource set is a second measurement value set; a type of the second measurement value set is either a first type or a second type; the first type includes UL TDOA, and the second type includes multi-RTT; a type of the second node is one of a base station or LMF; the type of the second measurement value set is used to determine a type of a receiver of the second measurement value set.

In one embodiment, the fourth information block is transmitted via a MAC CE.

In one embodiment, the fourth information block is transmitted via a Physical Layer Dynamic Performance.

In one embodiment, the fourth information block is transmitted through an RRC signaling.

In one embodiment, the fourth information block is used to trigger the first node's reporting of Association Information about the SRS resource in the first time-frequency resource set and the first time value.

In one embodiment, the type of the second measurement value set is the first type, and the type of the receiver of the second measurement value set is base station.

In one embodiment, the type of the second measurement value set is the second type, and the type of the receiver of the second measurement value set is LMF.

In one embodiment, the first measurement value set comprises the second measurement value set.

In one embodiment, the second measurement value set comprises the first measurement value set.

In one embodiment, the first measurement value set and the second measurement value set belong to a same report.

In one embodiment, the second node transmits the second measurement value set.

In one embodiment, the second node obtains the second measurement value set based on measurements.

In one embodiment, the step S70 is located before the step S10 in Embodiment 5.

In one embodiment, the step S70 is located after the step S10 and before the step S11 in Embodiment 5.

In one embodiment, the step S80 is located after the step S20 in Embodiment 6.

In one embodiment, the step S80 is after the step S20 and before the step S21 in Embodiment 6.

### Embodiment 9

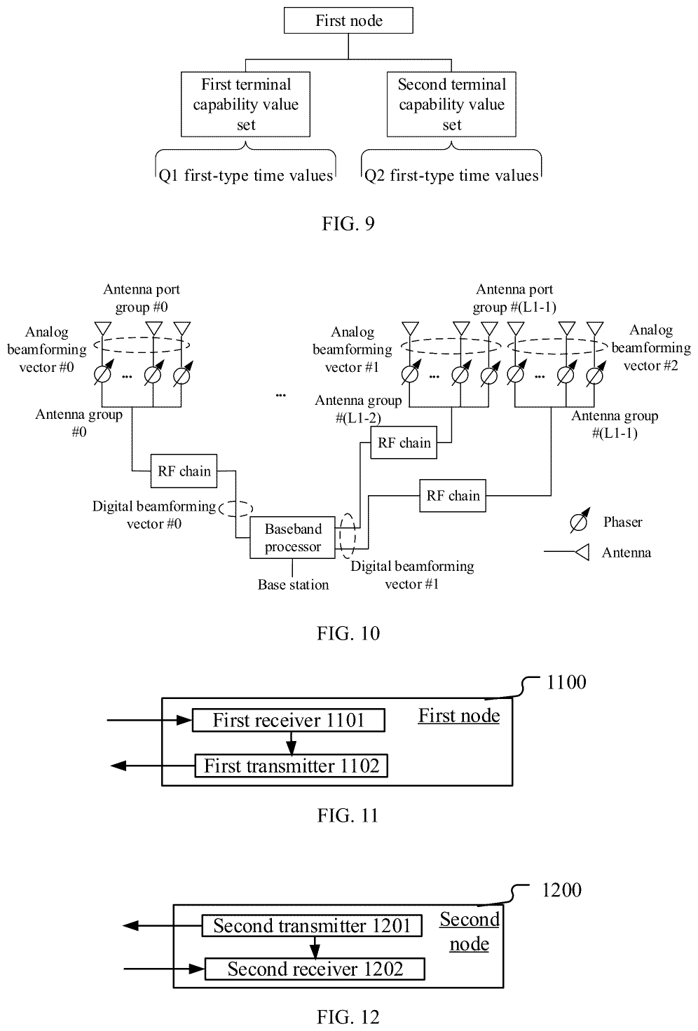

Embodiment 9 illustrates a schematic of a first terminal capability value set, as shown in FIG. 9. In FIG. 9, the first node comprises the first terminal capability value set and the second terminal capability value set; the first terminal capability value set is associated to Q1 first-type time values and the second terminal capability value set is associated to Q2 first-type time values; Q1 and Q2 are both positive integers greater than 1.

In one embodiment, the first terminal capability value set is associated to a first panel and the second terminal capability value set is associated to a second panel.

In one embodiment, the first panel corresponds to one RF Chain of the first node and the second panel corresponds to another RF Chain of the first node.

In one embodiment, the first terminal capability value set corresponds to Q1 SRS resources, and the Q1 SRS resources correspond to the Q1 first-type time values, respectively.

In one embodiment, the first terminal capability value set corresponds to Q1 SRS resource sets, and the Q1 SRS resource sets correspond to the Q1 first-type time values, respectively.

In one embodiment, the second terminal capability value set corresponds to Q2 SRS resources, and the Q2 SRS resources correspond to the Q2 first-type time values, respectively.

In one embodiment, the second terminal capability value set corresponds to Q2 SRS resource sets, and the Q2 SRS resource sets correspond to the Q2 first-type time values, respectively.

In one embodiment, the Q1 first-type time values correspond to Q1 UE Tx TEGs, respectively.

In one embodiment, the Q1 first-type time values correspond to Q1 TEG IDs, respectively.

In one embodiment, the Q2 first-type time values correspond to Q2 UE Tx TEGs, respectively.

In one embodiment, the Q2 first-type time values correspond to Q2 TEG IDs, respectively.

In one embodiment, the Q1 is equal to the Q2.

In one subembodiment, the Q1 SRS resources corresponding to the first terminal capability value set respectively use the same Q1 TEG IDs as the Q2 SRS resources corresponding to the second terminal capability value set.

In one subembodiment, the Q1 SRS resource sets corresponding to the first terminal capability value set respectively use the same Q1 TEG IDs as the Q2 SRS resource sets corresponding to the second terminal capability value set.

### Embodiment 10

Embodiment 10 illustrates a schematic diagram of antennas and antenna port groups, as shown in FIG. 10.

In Embodiment 10, an antenna port group consists of a positive integer number of antenna port(s); an antenna port is formed by superimposing antennas in a positive integer number of antenna group(s) through Antenna Virtualization. One antenna group is connected to a baseband processor through a Radio Frequency (RF) chain, so each antenna group corresponds to a different RF chain. Mapping coefficients of all antennas in a positive integer number of antenna group(s) comprised by a given antenna port to the given antenna port constitute a beamforming vector corresponding to the given antenna port. Mapping coefficients of multiple antennas comprised in any given one of a positive integer number of antenna groups comprised by the given antenna port to the given antenna port constitute an analog beamforming vector for the given antenna port. Analog beamforming vectors respectively corresponding to the positive integer number of antenna groups are diagonally arranged to form an analog beamforming matrix corresponding to the given antenna port. Mapping coefficients of the positive integer number of antenna groups to the given antenna port constitute a digital beamforming vector corresponding to the given antenna port. A beamforming vector corresponding to the given antenna port is a product of the analog beamforming matrix and the digital beamforming vector respectively corresponding to the given antenna port. Each antenna port in antenna port group is composed of (a) same antenna group(s), and different antenna ports in a same antenna port group correspond to different beamforming vectors.

FIG. 10 illustrates two antenna port groups, which are antenna port group #0 and antenna port group #1. Herein, the antenna port group is composed of antenna group #0, while the antenna port group #1 is composed of antenna group #1 and antenna group #2. Mapping coefficients of multiple antennas comprised in the antenna group #0 to the antenna port group #0 constitute an analog beamforming vector #0; a mapping coefficient of the antenna group #0 to the antenna port group #0 constitute a digital beamforming vector #0. Mapping coefficients of multiple antennas comprised in the antenna group #1 to the antenna port group #1 and mapping coefficients of multiple antennas comprised in the antenna group #2 to the antenna port group #1 respectively constitute an analog beamforming vector #1 and an analog beamforming vector #2; respective mapping coefficients of the antenna group #1 and the antenna group #2 to the antenna port group #1 constitute a digital beamforming vector #1. A beamforming vector corresponding to any antenna port comprised by the antenna port group #0 is a product of the analog beamforming vector #0 and the digital beamforming vector #0. A beamforming vector corresponding to any antenna port comprised by the antenna port group #1 is a product of the digital beamforming vector #1 and an analog beamforming matrix formed by diagonally arrangement of the analog beamforming vector #1 and the analog beamforming vector #2.

In one subembodiment, an antenna port group comprises one antenna port. For example, the antenna port group #0 in FIG. 14 comprises one antenna port.

In one subsidiary embodiment of the above subembodiment, an analog beamforming matrix corresponding to the one antenna port is dimensionally reduced to an analog beamforming vector, while a digital beamforming vector corresponding to the one antenna port is dimensionally reduced to a scaler, a beamforming vector corresponding to the one antenna port is equivalent to an analog beamforming vector corresponding to the one antenna port.

In one subembodiment, an antenna port group comprises multiple antenna ports. For example, the antenna port group #1 in FIG. 14 comprises multiple antenna ports.

In one subsidiary embodiment of the above subembodiment, the multiple antenna ports correspond to a same analog beamforming matrix and different digital beamforming vectors.

In one subembodiment, antenna ports in different antenna port groups correspond to different analog beamforming matrices.

In one subembodiment, any two antenna ports in an antenna port group are Quasi-Colocated (QCL).

In one subembodiment, any two antenna ports in an antenna port group are spatial QCL.

In one embodiment, the L1 second-type time values correspond to L1 antenna port groups in the figure, respectively.

In one embodiment, the L1 second-type time values correspond to multiple antenna port groups in the figure, respectively.

In one embodiment, the L1 second-type of time values correspond to L1 TEG IDs, respectively.

In one embodiment, the L1 second-type time values correspond to L1 TRP Rx TEG IDs, respectively.

In one embodiment, the L1 second-type time values correspond to L1 RFs, respectively.

In one embodiment, the L1 second-type time values correspond to L1 RF chains, respectively.

In one embodiment, the L1 second-type time values correspond to L1 receiving antenna ports, respectively.

In one embodiment, the L1 second-type time values correspond to L1 receiving antenna port groups, respectively.

In one embodiment, the L1 second-type time values correspond to L1 receiving antennas, respectively.

In one embodiment, the base station comprises L1 receiving antenna port groups, corresponding to antenna port group #0 through antenna port group #(L1-1) in the figure, respectively.

In one embodiment, the base station comprises L1 receiving antenna groups corresponding to antenna group #0 through antenna group #(L1-1) in the figure, respectively.

### Embodiment 11

Embodiment 11 illustrates a structure block diagram of a first node, as shown in FIG. 11. In FIG. 11, a first node 1100 comprises a first receiver 1101 and a first transmitter 1102.

The first receiver 1101 receives a third information block;
the first transmitter 1102 transmits a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and transmitting a reference signal in each SRS resource of a first time-frequency resource set, the first time-frequency resource set comprising at least one SRS resource.

In Embodiment 11, the first time-frequency resource set is known at a location-based service center, and a transmission timing error of a reference signal transmitted in any SRS resource of the first time-frequency resource set does not exceed the first time value; the third information block is used to determine a first time-frequency resource pool, the first time-frequency resource pool comprising the first time-frequency resource set.

In one embodiment, the first transmitter 1102 transmits a first CSI set, the first CSI set comprising at least one CSI; the first information block indicates that the first CSI set is associated with the first terminal capability value set.

In one embodiment, the second information block is used to indicate a first identity, the first time-frequency resource set being associated with the first identity.

In one embodiment, the first receiver 1101 receives a first signal in a second time-frequency resource set; the first signal is used to generate the first CSI set.

In one embodiment, a receiver of the reference signal transmitted in each SRS resource of the first time-frequency resource set includes a second node, the second node being associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes RTOA; the first reference signal is a reference signal transmitted in at least one SRS resource of the first time-frequency resource set.

In one embodiment, the first receiver 1101 receives a fourth information block; the fourth information block is used to trigger that the first information block and the second information block are used together to indicate the first time value; a measurement result for transmitting the reference signal in the SRS resource in the first time-frequency resource set is a second measurement value set; a type of the second measurement value set is either a first type or a second type; the first type includes UL TDOA, and the second type includes multi-RTT; a type of the transmitter of the fourth information block is one of a base station or LMF; the type of the second measurement value set is used to determine a type of a receiver of the second measurement value set.

In one embodiment, the first receiver 1101 comprises at least the first four of the antenna 452, the receiver 454, the multi-antenna receiving processor 458, the receiving processor 456 and the controller/processor 459 in Embodiment 4.

In one embodiment, the first transmitter 1102 comprises at least the first four of the antenna 452, the transmitter 454, the multi-antenna transmitting processor 457, the transmitting processor 468 and the controller/processor 459 in Embodiment 4.

In one embodiment, the first information block indicates a first terminal capability value set, with candidates for the first terminal capability value set including K1 terminal capability values, and the second information block indicates multiple first-type time values, and the first information block and the second information block both indicate a first time value, the first time value being one of the multiple first-type time values; and a reference signal is transmitted in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value; the multiple first-type time values correspond to multiple UE Tx TEGs, and the multiple first-type time values correspond to multiple TEG IDs.

### Embodiment 12

Embodiment 12 illustrates a structure block diagram of a second node, as shown in FIG. 12. In FIG. 12, a second node 1200 comprises a second transmitter 1201 and a second receiver 1202.

The second transmitter 1201 transmits a third information block;
the first receiver 1202 receives a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and receiving a reference signal in each SRS resource of a first time-frequency resource set, the first time-frequency resource set comprising at least one SRS resource.

In Embodiment 12, the first time-frequency resource set is known at a location-based service center, and a transmission timing error of a reference signal transmitted in any SRS resource of the first time-frequency resource set does not exceed the first time value; the third information block is used to determine a first time-frequency resource pool, the first time-frequency resource pool comprising the first time-frequency resource set.

In one embodiment, the second receiver 1202 receives a first CSI set, the first CSI set comprising at least one CSI; the first information block indicates that the first CSI set is associated with the first terminal capability value set.

In one embodiment, the second information block is used to indicate a first identity, the first time-frequency resource set being associated with the first identity.

In one embodiment, the second transmitter 1201 transmits a first signal in a second time-frequency resource set; the first signal is used to generate the first CSI set.

In one embodiment, the second node is associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes RTOA; the first reference signal is a reference signal transmitted in at least one SRS resource of the first time-frequency resource set.

In one embodiment, the second transmitter 1201 transmits a fourth information block; the fourth information block is used to trigger that the first information block and the second information block are used together to indicate the first time value; a measurement result for transmitting the reference signal in the SRS resource in the first time-frequency resource set is a second measurement value set; a type of the second measurement value set is either a first type or a second type; the first type includes UL TDOA, and the second type includes multi-RTT; a type of the second node is one of a base station or LMF; the type of the second measurement value set is used to determine a type of a receiver of the second measurement value set.

In one embodiment, the second transmitter 1201 comprises at least the first four of the antenna 420, the transmitter 418, the multi-antenna transmitting processor 471, the transmitting processor 414 and the controller/processor 475 in Embodiment 4.

In one embodiment, the second receiver 1202 comprises at least the first four of the antenna 420, the receiver 418, the multi-antenna receiving processor 472, the receiving processor 470 and the controller/processor 475 in Embodiment 4.

In one embodiment, the first information block indicates a first terminal capability value set, with candidates for the first terminal capability value set including K1 terminal capability values, and the second information block indicates multiple first-type time values, and the first information block and the second information block both indicate a first time value, the first time value being one of the multiple first-type time values; and a reference signal is transmitted in each SRS resource of the first time-frequency resource set, the first time-frequency resource set comprising at least one SRS resource; the first time-frequency resource set is known at a location-based service center, and a transmission timing error of a reference signal transmitted in any SRS resource of the first time-frequency resource set does not exceed the first time value; the multiple first-type time values correspond to multiple UE Tx TEGs, and the multiple first-type time values correspond to multiple TEG IDs.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned arial vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and transmitting a reference signal in each SRS resource of a first time-frequency resource set, the first time-frequency resource set comprising at least one SRS resource;
wherein the first time-frequency resource set is known at a location-based service center, and a transmission timing error of a reference signal transmitted in any SRS resource of the first time-frequency resource set does not exceed the first time value.

2. The first node according to claim 1, characterized in comprising:
the first transmitter, transmitting a first CSI set, the first CSI set comprising at least one CSI;
wherein the first information block indicates that the first CSI set is associated with the first terminal capability value set.

3. The first node according to claim 1, characterized in comprising:
a first receiver, receiving a third information block;
wherein the third information block is used to determine a first time-frequency resource pool, the first time-frequency resource pool comprising the first time-frequency resource set.

4. The first node according to claim 1, characterized in that the second information block is used to indicate a first identity, the first time-frequency resource set being associated with the first identity.

5. The first node according to claim 2, characterized in comprising:
the first receiver, receiving a first signal in a second time-frequency resource set;
wherein the first signal is used to generate the first CSI set.

6. The first node according to claim 1, characterized in that a receiver of the reference signal transmitted in each SRS resource of the first time-frequency resource set includes a second node, the second node being associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values;
any measurement value among the L1 measurement values includes RTOA; the first reference signal is a reference signal transmitted in at least one SRS resource of the first time-frequency resource set.

7. The first node according to claim 1, characterized in comprising:
a first receiver, receiving a fourth information block;
wherein the fourth information block is used to trigger that the first information block and the second information block are used together to indicate the first time value; a measurement result for transmitting the reference signal in the SRS resource in the first time-frequency resource set is a second measurement value set;
a type of the second measurement value set is either a first type or a second type; the first type includes UL TDOA, and the second type includes multi-RTT; a type of a transmitter of the fourth information block is one of a base station or LMF; the type of the second measurement value set is used to determine a type of a receiver of the second measurement value set.

8. The first node according to claim 1, characterized in that the first information block indicates a first index, the first index being associated with the first terminal capability value set.

9. The first node according to claim 1, characterized in that the location-based service center includes at least one of LMF or AMF.

10. The first node according to claim 1, characterized in that that the first time-frequency resource set is known at a location-based service center means at least one of:
the first time-frequency resource set is configured directly via the location-based service center; or
the first time-frequency resource set is configured to a base station via the location-based service center and then to the first node via the base station; or
the first time-frequency resource set is unknown at the base station; or
the first time-frequency resource set is communicated to a serving base station of the first node via the first node; or
the first time-frequency resource set is configured following LTE Positioning Protocol (LPP); or
the first time-frequency resource set is configured following NR Positioning Protocol A (NRPPA).

11. A second node for wireless communications, comprising:
a second receiver, receiving a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and receiving a reference signal in each SRS resource of a first time-frequency resource set, the first time-frequency resource set comprising at least one SRS resource;
wherein the first time-frequency resource set is known at a location-based service center, and a transmission timing error of a reference signal transmitted in any SRS resource of the first time-frequency resource set does not exceed the first time value.

12. The second node according to claim 11, characterized in comprising:
the second receiver, receiving a first CSI set, the first CSI set comprising at least one CSI;
wherein the first information block indicates that the first CSI set is associated with the first terminal capability value set.

13. The second node according to claim 11, characterized in comprising:
a second transmitter, transmitting a third information block;
wherein the third information block is used to determine a first time-frequency resource pool, the first time-frequency resource pool comprising the first time-frequency resource set.

14. The second node according to claim 11, characterized in that the second information block is used to indicate a first identity, the first time-frequency resource set being associated with the first identity.

15. The second node according to claim 12, characterized in comprising:
the second transmitter, transmitting a first signal in a second time-frequency resource set;
wherein the first signal is used to generate the first CSI set.

16. The second node according to claim 11, characterized in that the second node is associated with L1 second-type time values, L1 being a positive integer greater than 1; the second node transmits a first measurement value set, the L1 second-type time values respectively generating L1 measurement values based on reception of a first reference signal, the first measurement value set comprising the L1 measurement values; any measurement value among the L1 measurement values includes RTOA; the first reference signal is a reference signal transmitted in at least one SRS resource of the first time-frequency resource set.

17. The second node according to claim 11, characterized in comprising:
the second transmitter, transmitting a fourth information block;
wherein the fourth information block is used to trigger that the first information block and the second information block are used together to indicate the first time value; a measurement result for transmitting the reference signal in the SRS resource in the first time-frequency resource set is a second measurement value set;
a type of the second measurement value set is either a first type or a second type; the first type includes UL TDOA, and the second type includes multi-RTT; a type of the second node is one of a base station or LMF; the type of the second measurement value set is used to determine a type of a receiver of the second measurement value set.

18. A method in a first node for wireless communications, comprising:
transmitting a first information block and a second information block, the first information block indicating a first terminal capability value set, with candidates for the first terminal capability value set including K1 terminal capability values, and the second information block indicating multiple first-type time values, and the first information block and the second information block both indicating a first time value, the first time value being one of the multiple first-type time values; and transmitting a reference signal in each SRS resource of a first time-frequency resource set, the first time-frequency resource set comprising at least one SRS resource;
wherein the first time-frequency resource set is known at a location-based service center, and a transmission timing error of a reference signal transmitted in any SRS resource of the first time-frequency resource set does not exceed the first time value.

19. The method in the first node according to claim 18, characterized in comprising:
transmitting a first CSI set, the first CSI set comprising at least one CSI;
wherein the first information block indicates that the first CSI set is associated with the first terminal capability value set.

20. The method in the first node according to claim 18, characterized in comprising:
receiving a third information block;
wherein the third information block is used to determine a first time-frequency resource pool, the first time-frequency resource pool comprising the first time-frequency resource set.
